(19) United States
(12) Patent Application Publication
(10) Pub. No.: US 2013/0170789 A1
(43) Pub. Date: Jul. 4, 2013

(54) OPTICAL FIBER ARRAY STRUCTURE

(71) Applicant: Wen-Lung Kuang, Taoyuan County (TW)

(72) Inventor: Wen-Lung Kuang, Taoyuan County (TW)

(21) Appl. No.: 13/525,446

(22) Filed: Jun. 18, 2012

(30) Foreign Application Priority Data
Jan. 2, 2012 (TW) 101100068

(51) Int. Cl. G02B 6/12

(52) U.S. Cl. 385/14

(57) ABSTRACT

An optical fiber array structure includes a substrate covered with a cover plate and defining therebetween a longitudinal rectangular groove with a bottom wall and two opposite lateral contact walls, an optical fiber cable consisting of multiple optical fiber layers arranged in an array in the longitudinal rectangular groove in such a manner that the optical fibers of each two adjacent optical fiber layers are arranged in a staggered manner so that the center of one optical fiber of one optical fiber layer is kept in alignment with the contact area between two adjacent optical fibers of one adjacent optical fiber layer. This design effectively reduces light loss, phase noise and crosstalk, improves yield rate for mass production and assures a high level of optical signal transmission quality and reliability.

This application claims the priority benefit of Taiwan patent application number 101100068 filed on Jan. 2, 2012.

### BACKGROUND OF THE INVENTION

1. Field of the Invention

The present invention relates to optical fiber array technology and more particularly, to an optical fiber array structure, which comprises a substrate having a longitudinal rectangular groove located on a mating face thereof, an optical fiber cable consisting of multiple optical fiber layers of arranged and stacked in the form of an array in the longitudinal rectangular groove, a cover plate covered on the mating face of the substrate to hold down the optical fibers of the optical fiber cable in position, enabling the error tolerance to be evenly distributed over the optical fibers so that the yield rate can be greatly improved, assuring a high level of optical signal transmission quality and reliability.

2. Description of the Related Art

Following fast development of internet and communication technology and high density installation of telephone networks, the distance between people becomes closed. Cables are intensively used to transmit electrical and optical signals. Nowadays, fiber optics or optical fiber cables are intensively used to substitute for conventional metal cables for the advantages of excellent electromagnetic interference and noise reduction capability, light weight, long signal transmission distance, and good confidentiality.

Further, the basic architecture of fiber optic communication is to convert electrical signal into optical signal and then to transmit optical signal to the receiver end through an optical fiber cable. The receiver end has means to convert optical signal into electrical signal. Following bandwidth increase and demand for more channels, optical fiber array of high light coupling rate is the best choice. Optical fiber array is an important device for connection between an optical fiber cable and a mating device. It is mainly used in the connection between an optical fiber cable and a programmable logic controller (PLC), Dense wavelength division multiplexing (DWDM), optical cross-connect (OXC), optical add-drop multiplexer (OADM), optical router or photoelectric switch. During installation of an optical fiber array, the optical fiber array is put in alignment with a laser diode array. At this time, it is necessary to find the position for maximum light coupling rate for the laser diode array and the optical fiber array so that the alignment can be done, facilitating further bonding procedure. Another method is known without alignment of light coupling position. However, the yield rate of this method relies upon the bonding (glue bonding, soft soldering or laser welding) between the optical fiber array and the substrate. Thus, this method can eliminate pre-alignment.

Conventional substrates for optical fiber array are commonly glass substrates with V-grooves. During installation, multiple optical fibers are respectively arranged in the V-grooves of multiple glass substrates, and then the multiple glass substrates are arranged in a stack, forming an optical fiber array. By means of the V-grooves, the optical fibers are kept in direction, assuring optical fiber alignment precision. This method requires the use of a cutting tool to cut V-grooves on the glass substrates. However, every cutting operation creates one respective error tolerance. Thus, the positioning precision of each optical fiber is lowered. As optical fibers have a different positioning precision, the insertion loss (IL) will be increased and the return loss (RL) will be reduced, thereby affecting the optical signal transmission quality. Further, stacking up multiple glass substrates consumes much operation time, lowering the fabrication speed and increasing the fabrication cost. When increasing the number of optical fibers to satisfy transmission capacity requirement, the product cost and the product size will be relatively increased.

Therefore, it is desirable to provide an optical fiber array structure, which eliminates the aforesaid problems.

### SUMMARY OF THE INVENTION

The present invention has been accomplished under the circumstances in view. It is therefore the main object of the present invention to provide an optical fiber array structure, which facilitates optical fiber installation and greatly improves optical fiber positioning precision. It is another object of the present invention to provide an optical fiber array structure, which enables the error tolerance to be evenly distributed over the optical fibers, thereby improving yield rate for mass production, effectively reducing light loss, phase noise and crosstalk, and assuring a high level of optical signal transmission quality and reliability.

To achieve this and other objects of the present invention, an optical fiber array structure comprises a substrate, a cover plate covered on the substrate, a longitudinal rectangular groove surrounded by the substrate and the cover plate and defining a bottom wall and two opposite lateral contact walls, and an optical fiber cable consisting of multiple optical fiber layers arranged in an array and positioned in the longitudinal rectangular groove.

In one example of the invention, the optical fiber layers consist of a same number of optical fibers. In this example, each optical fiber layer has one lateral side thereof abutted against one the lateral contact wall of the longitudinal rectangular groove of the substrate, and an opposite lateral side thereof spaced from the other lateral contact wall of the longitudinal rectangular groove of the substrate by a gap.

In another example of the invention, one of each two adjacent optical fiber layer consists of one more optical fiber than the other of each two adjacent optical fiber layer. Further, one of each two adjacent optical fiber layers has two opposite lateral sides thereof respectively abutted against the two lateral contact walls of the longitudinal rectangular groove of the substrate and the other of each two adjacent optical fiber layers has two opposite lateral sides thereof respectively spaced from the two lateral contact walls of the longitudinal rectangular groove of the substrate by a gap.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic top view of an optical fiber array structure in accordance with the present invention.

FIG. 2 is schematic front view of the optical fiber array structure in accordance with the present invention.

FIG. 3 is an enlarged view of FIG. 2.

FIG. 4 illustrates the test data obtained from the optical fiber array structure in accordance with the present invention.

FIG. 5 is an Insertion Loss-vs-Polarization chart in accordance with the present invention (I).

FIG. 6 is an Insertion Loss-vs-Polarization chart in accordance with the present invention (II).

FIG. 7 is an Insertion Loss-vs-Polarization chart in accordance with the present invention (III).

FIG. 8 is a schematic front view of an alternate form of the optical fiber array structure in accordance with the present invention.

FIG. 9 is a schematic front view of another alternate form of the optical fiber array structure in accordance with the present invention.

FIG. 10 is a schematic front view of still another alternate form of the optical fiber array structure in accordance with the present invention.

### DETAILED DESCRIPTION OF THE PREFERRED EMBODIMENT

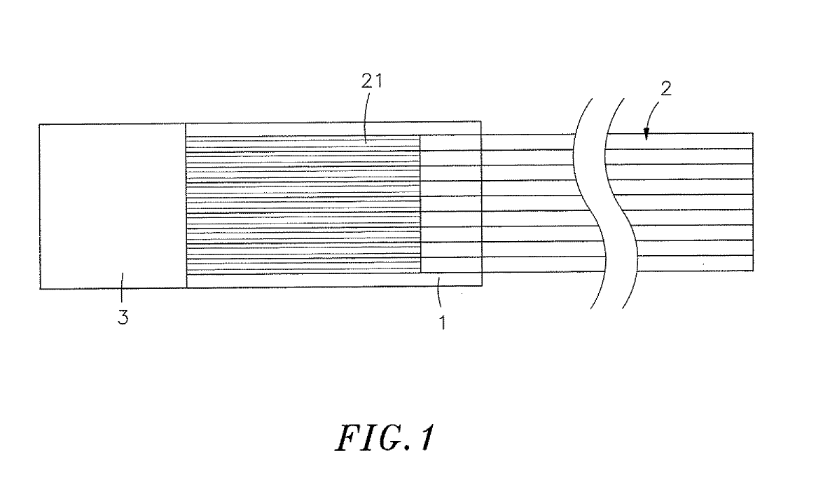

Referring to FIGS. 1, 2 and 3, an optical fiber array structure in accordance with the present invention is shown. The optical fiber array structure comprises a substrate 1, an optical fiber cable 2, and a cover plate 3.

The substrate 1 has a mating face 11 processed through a high precision machining process to provide a longitudinal rectangular groove 12. The longitudinal rectangular groove 12 defines a bottom wall 122 horizontally disposed at the bottom side, and two opposite lateral contact walls 121 respectively vertically disposed at two opposite lateral sides of the bottom wall 122.

The optical fiber cable 2 comprises a plurality of optical fibers 21 positioned in the longitudinal rectangular groove 12 of the substrate 1. The optical fibers 21 are arranged into multiple optical fiber layers 211 and stacked in the form of an array in the longitudinal rectangular groove 12. The optical fiber layers 211 each consist of a same number of optical fibers 21. Each optical fiber layer 211 consists of more than four optical fibers 21. The optical fibers 21 of each two adjacent optical fiber layers 211 are arranged in a staggered manner so that the center of one optical fiber 21 of one optical fiber layer 211 is kept in alignment with the contact area between two adjacent optical fibers 21 of the other optical fiber layer 211. Further, each optical fiber layer 211 has one lateral side abutted against one lateral contact wall 121 of the longitudinal rectangular groove 12 of the substrate 1, and the other lateral side spaced from the other lateral contact wall 121 of the longitudinal rectangular groove 12 of the substrate 1 by a gap 22. The gap 22 has a width approximately equal to the radius of the cross section of each optical fiber 21. Each two adjacent optical fiber layers 211 have one respective lateral side respectively abutted against the two lateral contact walls 121 of the longitudinal rectangular groove 12 of the substrate 1. Further, the optical fibers 21 can be single-mode or multi-mode glass optical fibers, plastic-clad silica optical fibers or plastic optical fibers, having a diameter about 125 μm. There are two types of multimode fibers classified subject to their dispersion characteristics. One type is step-index multimode fiber and the other type is graded-index multimode fiber. Further, to solve the problem of dispersion of colors and variation of polarization, dispersion-shifted fiber, non-zero dispersion-shifted fiber, dispersion-compensating fiber and polarization maintaining fiber (PMF), and etc. are created for different purposes.

The cover plate 3 is located on the top side of the substrate 1, comprising a planar mating face 31. Further, the cover plate 3 has a width about 5.0±0.2 mm, and a length about 2.6˜2.0 mm.

Further, micro-milling, micro-cutting, micro-grinding or any other high precision machining technique may be employed to form the rectangular locating groove 12 in the mating face 11 of the substrate 1. The machining precision can reach submicron grade (i.e., within the range of 1 micron=10⁻⁶ m=1 μm), to obtain precision size and surface coarseness. An adhesive is applied to the mating face 11 of the substrate 1 by means of coating, mold casting or spot gluing technique, and the stripped optical fibers 21 of the optical fiber cable 2 are properly set in the rectangular locating groove 12 in the mating face 11 of the substrate 1 in the predetermined form of an array, and then the cover plate 3 is covered on the substrate 1 to abut its planar mating face 31 against the mating face 11 of the substrate 1. When the applied adhesive is cured, the substrate 1, the optical fibers 21 of the optical fiber cable 2 and the cover plate 3 are fixedly secured together.

The optical fibers 21 of the optical fiber cable 2 are respectively kept in contact with the bottom wall 122 and lateral contact walls 121 of the longitudinal rectangular groove 12 of the substrate 1 and the optical fibers 21 of the adjacent optical fiber layer 211 or planar mating face 31 of the cover plate 3 in a 4-point contact manner and squeezed in position. The optical fibers 21 of the bottom optical fiber layer 211 are stopped against the bottom wall 122 of the longitudinal rectangular groove 12 of the substrate 1. The optical fibers 21 of the top optical fiber layer 211 are stopped against the planar mating face 31 of the cover plate 3, or spaced from the planar mating face 31 of the cover plate 3 at a predetermined distance. As the optical fibers 21 are respectively positioned in the groove between two adjacent optical fibers 21 of each adjacent optical fiber layer 211, the core pitch of each two adjacent optical fiber layers 211 can be kept relatively closer, decreasing the degree of polarization and enhancing the precision of the positioning of the optical fiber cable 2 in the substrate 1. Thus, it is not necessary to waste time in alignment, saving much the manufacturing time and cost.

Further, the installation number of the optical fibers 21 may be increased to fit different requirements or designs. By means of changing the size (width or height) of the locating groove 12 of the substrate 1, a different optical fiber cable 2 having a different number of optical fiber layers 211 (2, 3, 4, 5 or more layers) and a different number of optical fibers 21 (4, 5, 6, . . . 9, or more pieces of optical fibers) in each optical fiber layer 211 can be installed without changing the size of the substrate 1 and cover plate 3. Thus, the invention allows proper space arrangement to effectively solve the problems of insufficient channels, bandwidth limitation and large size. By means of increasing the number of optical fibers 21 in the locating groove 12 of the substrate 1 without changing the size of the substrate 1 and cover plate 3, the invention allows realization of a low profile design. Further, the locating groove 12 of the substrate 1 may have an error tolerance after machining. As the error tolerance is within a predetermined range and will be evenly distributed to every optical fiber 21 and every optical fiber layer 211, the positioning error tolerance of each optical fiber 21 will be relatively reduced when increasing the number of optical fiber layers 211 or the number of optical fibers 21 of each optical fiber layer 211 in the locating groove 12 of the substrate 1. As the optical fibers 21 are abutted against one another, reducing the positioning error tolerance can increase product precision and reduce insertion loss and increase return loss, resulting in improvement of optical signal transmission quality. By means of the application of the present invention to increase the number of optical fibers 21, the transmission capacity and quality are significantly improved, prolonging the lifespan of the technology or production line.

Further, the substrate 1 and the cover plate 3 can be prepared by Pyrex glass of coefficient of thermal expansion 32.5×10⁻⁷/° C., Borofloatx 33 of coefficient of thermal expansion 3.3×10⁻⁶/° C., Schott borosilicate glass (BK7 optical glass) of coefficient of thermal expansion 86×10⁻⁷/° C., quartz glass of coefficient of thermal expansion 5.5˜5.9×10⁻⁷/° C., monocrystalline silicon, polycrystalline silicon wafer, or any other suitable, hard, low thermal expansion material. Further, the substrate 1 and the cover plate 3 can be light transmissive (prepared by low thermal expansion glass, quartz glass, etc.). In this case, the adhesive for bonding the substrate 1, the optical fiber cable 2 and the cover plate 3 together can be selected from the group of polymethylmethacrylate (PMMA), UV curable resin, epoxy, phenolic resin, inorganic adhesive, anaerobic adhesive, thermoplastic polyurethane (TPU), pressure sensitive resin, thermally fused resin, or their combinations.

Alternatively, the substrate 1 and the cover plate 3 can be opaque (prepared by monocrystalline silicon, polycrystalline silicon wafer, etc.). In this case, anaerobic adhesive can be used to bond the substrate 1, the optical fiber cable 2 and the cover plate 3 together. By means of the applied adhesive, the gap between the substrate 1 and the cover plate 3 is tightly sealed, preventing accumulation of dust and other impurities in optical fiber array structure and well protecting the optical fiber cable 2, assuring a high level of optical signal transmission quality. Further, the optical fiber array can have a polygonal or cylindrical shape, or any other suitable shape, and its end face can be polished to have an angle of 8 or 6 degrees, or any other suitable degrees. Further, the end face is covered with a layer of anti-reflection coating by means of a coating technique for interference in light ray and wave filtration (1260 nm˜1650 nm), reducing polarization dependent loss (PDL) and improving light coupling efficiency.

In actual application of the optical fiber array structure, the optical fibers 21 of the optical fiber cable 2 can be polarization maintaining fibers (PMF) for use in a coherent optical communication and sensor system, such as fiber-optic gyroscope, fiber-optic underwater sonar, etc. When erbium-doped polarization maintaining fibers are selected for the optical fibers 21 of the optical fiber cable 2, the optical fiber array structure can be used in a high-power optical fiber amplifier, polarization maintaining coupler, or fiber laser. This kind of optical fibers 21 has the performance indexes of birefringence, beat length (L.B.) and extinction ratio (ER). Extinction ratio (ER) is directly related to Laser Signal Power and Bit Error Rate (BER) in an optical communication channel, and measured in (dB). It is a key parameter used to specify the reliability of signal transmission in optical transceivers. Extinction ratio (ER) must be greater than 20 dB to lower phase noise and crosstalk and to enhance the sensitivity of the sensor.

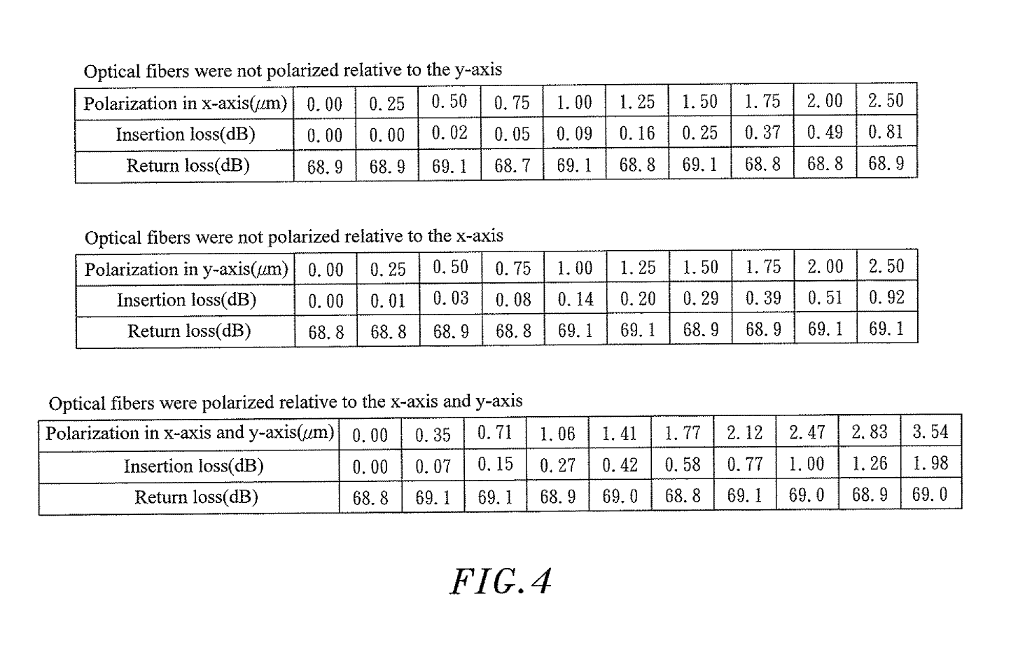

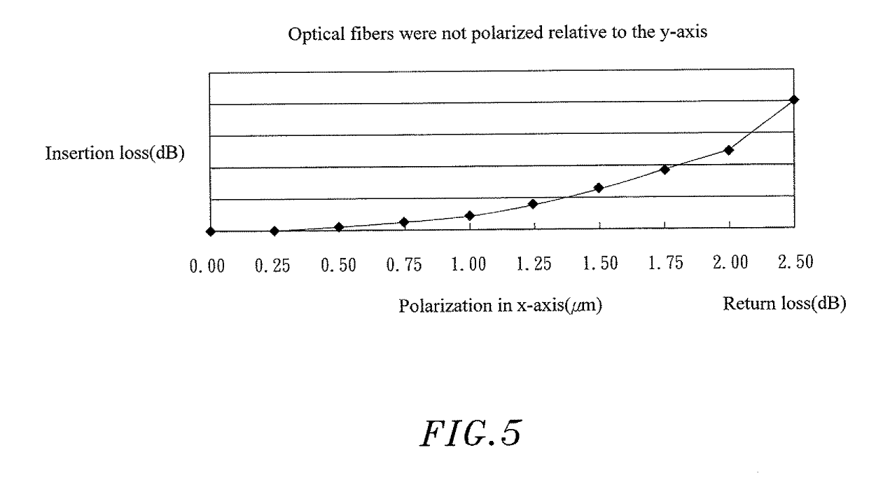

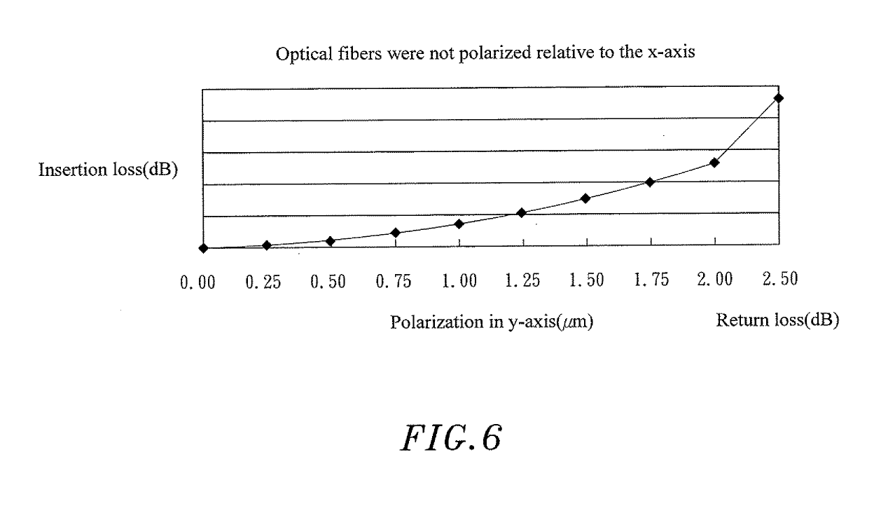

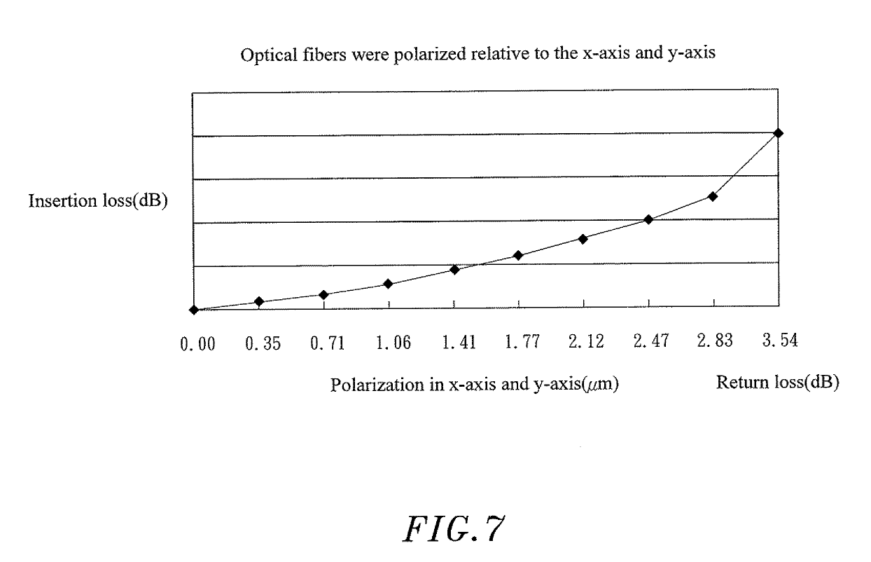

In order to achieve the aforesaid effects, the inventor made tests on the optical fibers 21 in three conditions to obtain the results shown in FIGS. 4, 5, 6 and 7. In the first condition, the optical fibers 21 were not polarized relative to the y-axis and differently polarized along the x-axis. In the second condition, the optical fibers 21 were not polarized relative to the x-axis and differently polarized along the y-axis. In the third condition, the optical fibers 21 were polarized along the y-axis and the x-axis. After analysis of the test results, it is noted that under the normal displacement range 1 μm, the insertion loss and return loss of the optical fibers 21 of the optical fiber layers 211 meet product standards. The test data indicates: Insertion Loss (IL) to be 0.09 dB, 0.14 dB and 0.27 dB respectively in the three test conditions, and all are smaller than 0.3 dB; Return Loss (RL) to be 69.1 dB, 69.1 dB and 68.9 dB respectively in the three test conditions, and all are larger than 50 dB. The invention has the multiple optical fiber layers 211 to be stacked up and the optical fibers 21 of the optical fiber layers 211 to be abutted firmly against one another. This optical fiber positioning design simply needs to make one single rectangular locating groove 12 in the mating face 11 of the substrate 1 through one single machining process, saving much fabrication time and cost. This single machining process (to form the lateral contact walls 121 and the bottom wall 122) minimizes error tolerance. By means of letting all the optical fibers 21 to share the error tolerance, the positioning precision of the optical fiber cable 2 in the substrate 1 is greatly improved, meeting product standards, effectively reducing light loss, phase noise and crosstalk, improving yield rate for mass production and assuring a high level of optical signal transmission quality and reliability.

In general, as shown in FIGS. 1-3, the invention provides an optical fiber array structure, which comprises a substrate 1 having a mating face 11 and a longitudinal rectangular groove 12 that is located on the mating face 11 and defining a bottom wall 122 and two opposite lateral contact walls 121, an optical fiber cable 2, which comprises multiple optical fiber layers 211 of optical fibers 21 arranged in an array in the longitudinal rectangular groove 12, a cover plate 3 covered on the mating face 11 of the substrate 1, and an adhesive bonding the substrate 1, the optical fibers 21 of the optical fiber cable 2 and the cover plate 3 together. This design greatly improves the positioning precision of the optical fiber cable 2 in the substrate 1, meeting product standards. Thus, the invention effectively reduces light loss, phase noise and crosstalk, improves yield rate for mass production and assures a high level of optical signal transmission quality and reliability.

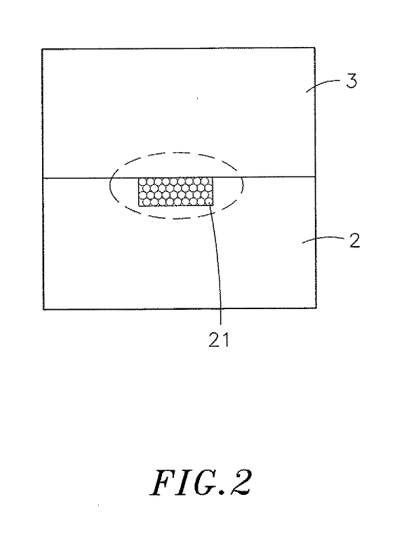

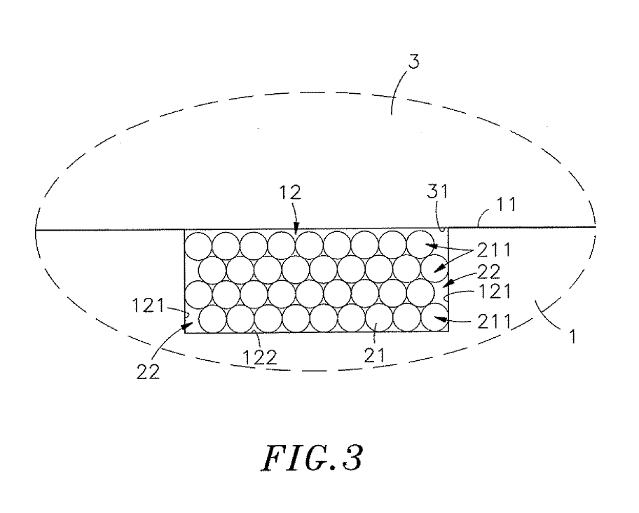

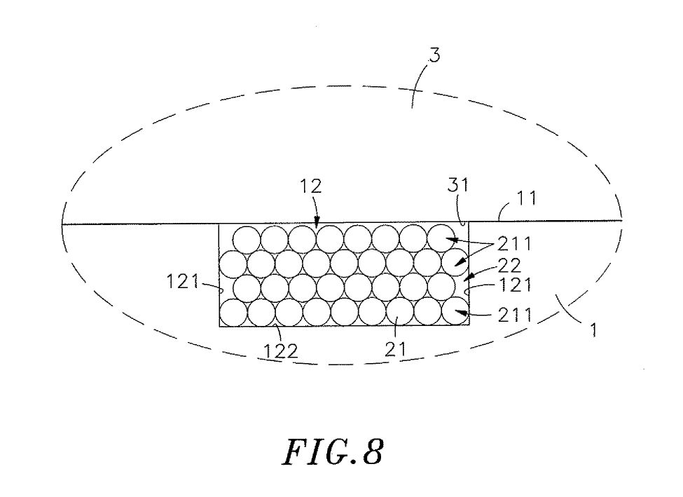

In the embodiment shown in FIGS. 2 and 3, all the optical fiber layers 211 have the same number of optical fibers 21. However, this is not a limitation. In an alternate form of the present invention, each two adjacent optical fiber layers 211 have a different number of optical fibers 21. One of each two adjacent optical fiber layers 211 can have, for example, 7, 8, 9, . . . , 12, 13 pcs of optical fibers 21, and the other of each two adjacent optical fiber layers 211 can have one more piece of optical fiber 21. In this case, as shown in FIG. 8, the two opposite lateral sides of one of each two adjacent optical fiber layers 211 are respectively abutted against the two opposite lateral contact walls 121 of the longitudinal rectangular groove 12, and the two opposite lateral sides of the other of each two adjacent optical fiber layers 211 are respectively spaced from the two opposite lateral contact walls 121 of the longitudinal rectangular groove 12 by a gap 22. Preferably, let one optical fiber layer 211 that includes one more optical fiber 21 be positioned on the bottom wall 122 of the longitudinal rectangular groove 12. However, this is not a limitation. By means of tool positioning application, one optical fiber layer 211 that has a less number of optical fibers 21 can be positioned on the bottom wall 122 of the longitudinal rectangular groove 12.

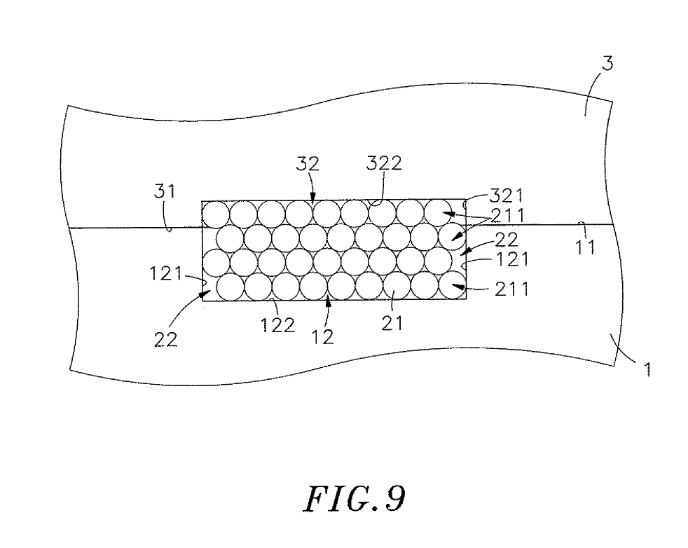

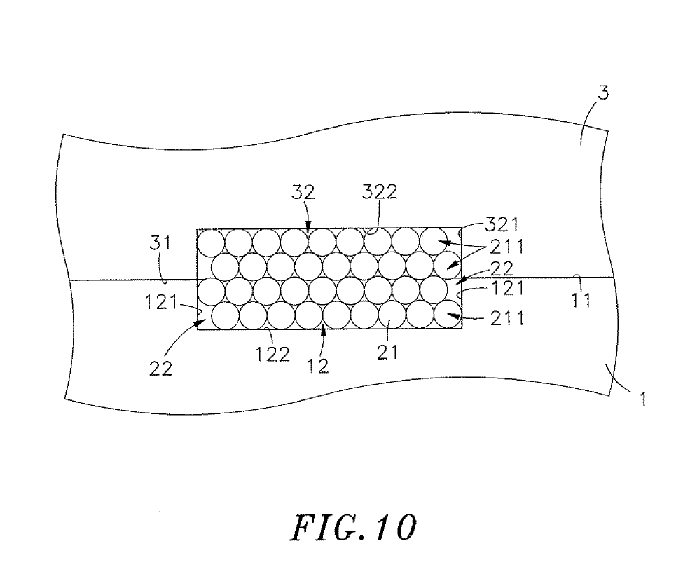

Referring to FIGS. 9 and 10 and FIG. 3 again, two longitudinal rectangular grooves 12 and 32 can be respectively formed in the mating face 11 of the substrate 1 and the mating face 31 of the cover plate 3 by machining. These two longitudinal rectangular grooves 12 and 32 can be made having the same depth or different depths. Further, each longitudinal rectangular groove 12/32 defines a bottom wall 122/322 and two opposite lateral contact walls 121/321. The optical fibers 21 of the optical fiber cable 2 are positioned in the longitudinal rectangular grooves 12 and 32 in between the substrate 1 and the cover plate 3 in such a manner that the optical fibers 21 of each two adjacent optical fiber layers 211 of the optical fibers 21 of the optical fiber cable 2 are arranged in a staggered manner; the top and bottom optical fiber layers 211 of the optical fibers 21 of the optical fiber cable 2 are respectively abutted against the bottom wall 322 of the longitudinal rectangular groove 32 on the mating face 31 of the cover plate 3 and the bottom wall 122 of the mating face 11 of the substrate 1.

Although particular embodiment of the invention have been described in detail for purposes of illustration, various modifications and enhancements may be made without departing from the spirit and scope of the invention. Accordingly, the invention is not to be limited except as by the appended claims.

What the invention claimed is:

1. An optical fiber array structure, comprising:
a substrate;
a cover plate covered on said substrate and defining with said substrate a longitudinal rectangular groove, said longitudinal rectangular groove defining a bottom wall and two opposite lateral contact walls respectively perpendicularly extended from two opposite lateral sides of said bottom wall; and
an optical fiber cable comprising multiple optical fiber layers arranged in an array in said longitudinal rectangular groove, said optical fiber layers of optical fibers comprising a same predetermined number of optical fibers, the optical fibers of each two adjacent said optical fiber layers being arranged in a staggered manner so that the center of one optical fiber of one optical fiber layer is kept in alignment with the contact area between two adjacent optical fibers of the other optical fiber layer, each said optical fiber layer having one lateral side thereof abutted against one said lateral contact wall of said longitudinal rectangular groove and an opposite lateral side thereof spaced from the other said lateral contact wall of said longitudinal rectangular groove by a gap.

2. The optical fiber array structure as claimed in claim 1, wherein said gap has a width approximately equal to the radius of the cross section of each said optical fiber.

3. The optical fiber array structure as claimed in claim 1, wherein said substrate comprises a mating face surrounding said longitudinal rectangular groove; said cover plate comprises a planar mating face pressed on said optical fiber layers of said optical fiber cable to hold down said optical fiber layers in said longitudinal rectangular groove; said optical fiber layers comprise a bottom optical fiber layer abutted against said bottom wall of said longitudinal rectangular groove, and a top optical fiber layer abutted against the planar mating face of said cover plate.

4. The optical fiber array structure as claimed in claim 1, wherein said cover plate has a width about 5.0±0.2 mm, and a length about 2.6˜2.0 mm.

5. The optical fiber array structure as claimed in claim 1, wherein said optical fibers are selected from the group of glass optical fibers, plastic-clad silica optical fibers and plastic optical fibers, having a diameter about 125 μm.

6. The optical fiber array structure as claimed in claim 1, wherein said optical fibers are selected from the group of single-mode and multi-mode glass optical fibers and polarization maintaining fiber.

7. The optical fiber array structure as claimed in claim 1, wherein said substrate and said cover plate are selected from the group of Pyrex glass of coefficient of thermal expansion 32.5×10⁻⁷/° C., Borofloat® 33 of coefficient of thermal expansion 3.3×10⁻⁶/° C., Schott borosilicate glass of coefficient of thermal expansion 86×10⁻⁷/° C., quartz glass of coefficient of thermal expansion 5.5˜5.9×10⁻⁷/° C., monocrystalline silicon and polycrystalline silicon wafer.

8. The optical fiber array structure as claimed in claim 1, wherein said substrate comprises a mating face located on a top side thereof; said cover plate comprises a mating face located on a bottom side thereof; said longitudinal rectangular groove is partially formed in the mating face of said substrate and partially formed in the mating face of said cover plate; said optical fiber layers comprise a bottom optical fiber layer abutted against said bottom wall of said longitudinal rectangular groove in the mating face of said substrate, and a top optical fiber layer stopped against the mating face of said cover plate.

9. An optical fiber array structure, comprising:
a substrate comprising a mating face;
a cover plate covered on said substrate, said cover plate comprising a mating face facing toward the mating face of said substrate;
a longitudinal rectangular groove defined in between said substrate and said cover plate and surrounded by the mating face of said substrate and the mating face of said cover plate, said longitudinal rectangular groove comprising a bottom wall and two opposite lateral contact walls respectively perpendicularly extended from two opposite lateral sides of said bottom wall; and
an optical fiber cable comprising multiple optical fiber layers arranged in an array in said longitudinal rectangular groove, the optical fibers of each two adjacent said optical fiber layers being arranged in a staggered manner so that the center of one optical fiber of one optical fiber layer is kept in alignment with the contact area between two adjacent optical fibers of the other optical fiber layer, one of each two adjacent said optical fiber layers having two opposite lateral sides thereof respectively abutted against said two lateral contact walls of said longitudinal rectangular groove and the other of each two adjacent said optical fiber layers having two opposite lateral sides thereof respectively spaced from the two lateral contact walls of said longitudinal rectangular groove by a gap.

10. The optical fiber array structure as claimed in claim 9, wherein said gap has a width approximately equal to the radius of the cross section of each said optical fiber.

11. The optical fiber array structure as claimed in claim 9, wherein said optical fiber layers comprise a bottom optical fiber layer abutted against said bottom wall of said longitudinal rectangular groove, and a top optical fiber layer abutted against the mating face of said cover plate.

12. The optical fiber array structure as claimed in claim 9, wherein said cover plate has a width about 5.0±0.2 mm, and a length about 2.6˜2.0 mm.

13. The optical fiber array structure as claimed in claim 9, wherein said optical fibers are selected from the group of glass optical fibers, plastic-clad silica optical fibers and plastic optical fibers, having a diameter about 125 μm.

14. The optical fiber array structure as claimed in claim 9, wherein said optical fibers are selected from the group of single-mode and multi-mode glass optical fibers and polarization maintaining fiber.

15. The optical fiber array structure as claimed in claim 9, wherein said substrate and said cover plate are selected from the group of Pyrex glass of coefficient of thermal expansion 32.5×10⁻⁷/° C., Borofloat® 33 of coefficient of thermal expansion 3.3×10⁻⁶/° C., Schott borosilicate glass of coefficient of thermal expansion 86×10⁻⁷/° C., quartz glass of coefficient of thermal expansion 5.5˜5.9×10⁻⁷/° C., monocrystalline silicon and polycrystalline silicon wafer.

16. The optical fiber array structure as claimed in claim 9, wherein one of each two adjacent said optical fiber layer consists of one more optical fiber than the other of each two adjacent said optical fiber layer.

17. The optical fiber array structure as claimed in claim 9, wherein said longitudinal rectangular groove is partially formed in the mating face of said substrate and partially formed in the mating face of said cover plate; said optical fiber layers comprise a bottom optical fiber layer abutted against said bottom wall of said longitudinal rectangular groove in the mating face of said substrate, and a top optical fiber layer stopped against the mating face of said cover plate.
